(19) United States
(12) Patent Application Publication
(10) Pub. No.: US 2009/0260500 A1
(43) Pub. Date: Oct. 22, 2009

(54) Shield quick-dismantling structure of sawing machine

(75) Inventor: Tian-Wang Wang, Taichung Hsien (TW)

Correspondence Address: Tian-Wang Wang, P.O. Box 44-2049, Taipei, 10668, TW

(73) Assignee: Mao Shan Machinery Industrial Co. Ltd.

(21) Appl. No.: 12/081,732

(22) Filed: Apr. 21, 2008

(51) Int. Cl. B27B 5/29; B27B 5/00

(52) U.S. Cl. 83/860; 83/478

(57) ABSTRACT

The present invention provides a quick dismantling and positioning structure for the saw blade of sawing machine; a n-shaped rod is defined, two guard plates and stoppers are correspondingly arranged at both sides to form a shield assembly; moreover, two moveable dampers are arranged within the rod, a quick-release bolt is externally mounted onto the front end of the moveable clamper, so that the shield assembly could be quickly dismantled or reassembled by screwing and release of the quick-release bolt.

### BACKGROUND OF THE INVENTION

(1) Field of the Invention

The present invention relates generally to a shield quick-dismantling structure of sawing machine, and more particularly to an innovative one which allows for rapid disassembly via quick-release bolts or rapid installation and fixation in order to improve the operating efficiency of sawing machine.

(2) Description of the Prior Art

The sawing machine is a widely used machine for woodworking. Thanks to its advantages of high strength and adjustability of height, the saw blade can be applied to saw any kind of timber. But, the saw blade must be maintained or replaced frequently during continuous processing, especially when the saw blade is covered with sawdust. Otherwise, the sawing efficiency of saw blade will be adversely affected, thus leading to rapid tear-and-wear.

Whenever the saw blade is maintained or replaced, the shield of saw blade must be firstly dismantled, and then reassembled and fixed, which will spend more time and affect the efficiency, and also bring about safety hazard of operators, making it necessary for improvement.

### SUMMARY OF THE INVENTION

The sawing machine of the present invention is developed and improved to facilitate the maintenance and replacement of saw blade. By combining two moveable dampers at inner side of the shield support and quick-release bolts outside the front moveable clamper, the present invention aims to enable the shield assemblies to be dismantled and positioned through screwing and releasing of quick-release bolts for improved efficiency.

The other purpose of the present invention is to combine the shield assemblies (including guard plate and stopper) and the support into an integrated shield for rapid and convenient dismantling and assembly.

### BRIEF DESCRIPTION OF THE DRAWINGS

FIG. 1 depicts a sketch view of sawing machine of the present invention.

FIG. 2 depicts an assembled view of the sawing machine and shield of the present invention.

FIG. 3 depicts an assembled view of shield assembly of the present invention.

FIG. 4 depicts an exploded perspective view of shield assembly of the present invention.

### DETAILED DESCRIPTION OF THE PREFERRED EMBODIMENTS

The structural composition, technology and efficacies of the present invention are described with reference to accompanied drawings:

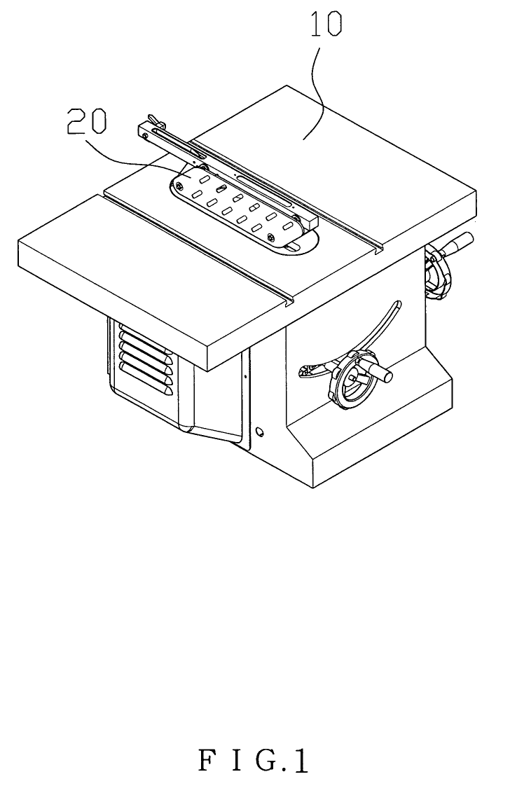

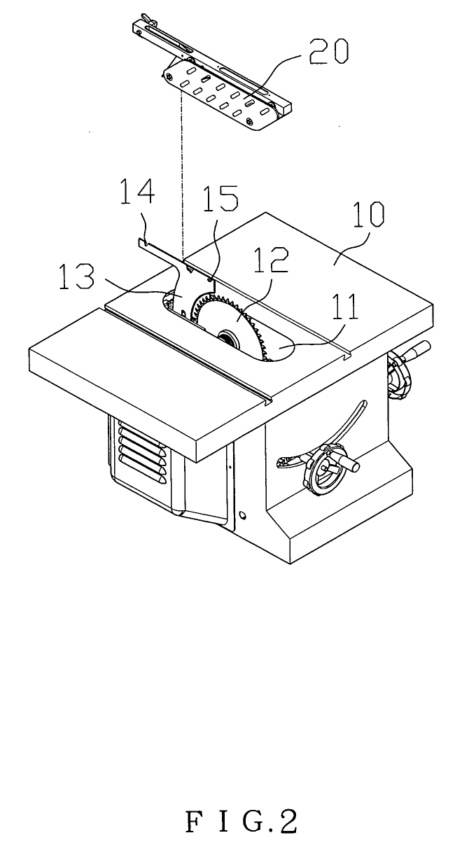

FIG. 1 depicts a sketch view of sawing machine of the present invention, and FIG. 2 depicts the assembled view of the shield assemblies of the sawing machine. A saw blade assembly 12 is placed in the kerf 11 preset centrally on the table of the sawing machine 10; the height of saw blade assembly 12 can be adjusted where applicable, a fixed support 13 is arranged at rear side of the saw blade assembly 12, and notched grooves 14, 15 mated with the shield 20 are placed on the upper end of the support 13.

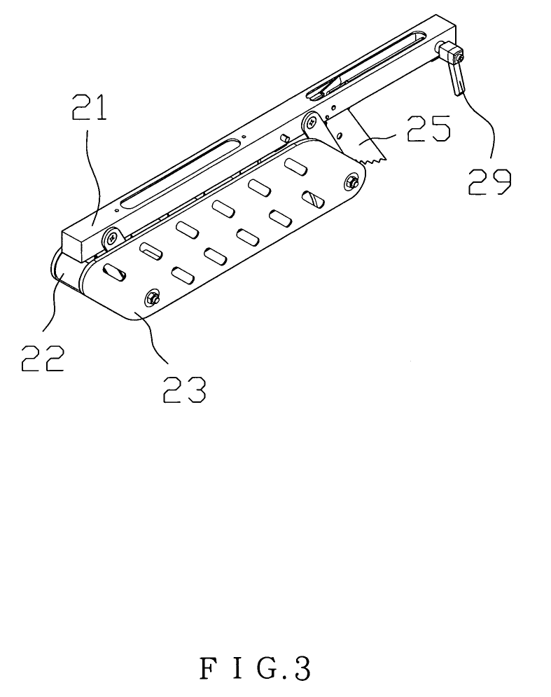

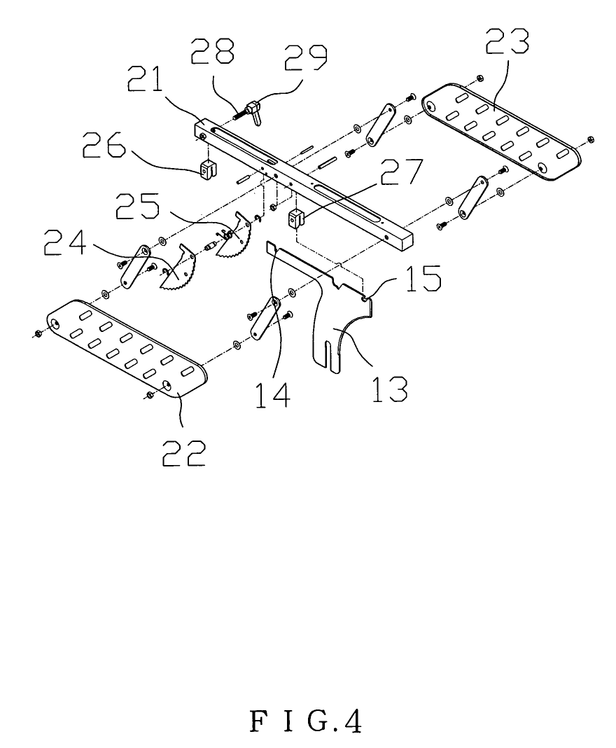

Referring also to FIGS. 3, 4, the shield assembly 20 is integrally composed of a U-shaped rod 21, two guard plates 22, 23 at both sides and two stoppers 24, 25 at rear side of the guard plate.

Within U-shaped space of the rod 21, moveable dampers 26, 27 with downward notch are separately arranged at notched groove 14, 15 over the support 13; when the shield assembly 20 is coupled with the sawing machine 10, two moveable dampers 26, 27 are snapped into two notched grooves 14, 15. In such case, the snapping operation could be realized by screwing the end handle 29 of the quick-release bolt penetrated by a bolt 28. So, the shield assembly (comprising a rod 21, guard plates 22, 23 and stoppers 24, 25) can be fixed securely onto the table of the sawing machine; conversely, the shield assembly could be easily dismantled if the handle 29 is loosened, and the clamping force of moveable damper 26 is released from the notched groove 14 on the support 13.

An integrated U-shaped rod 21 is defined together with the guard plates 22, 23 and stoppers 24, 25 in the shield assembly; through screwing and release of two moveable dampers 26, 27 and a fixed support 13 on the sawing machine, the shield assembly could be dismantled and positioned easily by quick-release bolts, thereby improving efficiently the operating efficiency and safety of operators.

What is claimed is:

1. A shield quick-dismantling structure of sawing machine, which comprising: a shield assembly that is composed of a U-shaped rod, guard plates and stoppers; a support fixed on the sawing machine correspondingly to the shield assembly; its' characterized in that:
two moveable dampers are arranged at inner side of U-shaped rod correspondingly to the upper notched groove of the support, and a quick-release bolt is penetrated externally from a moveable clamper, so that the quick-release bolt can be used for clamping or release of the shield assembly.

2. The device defined in claim 1, wherein the guard plate and stopper are integrally combined with U-shaped support.
